(19) United States
(12) Patent Application Publication
(10) Pub. No.: US 2003/0129431 A1
(43) Pub. Date: Jul. 10, 2003

(54) COMPOSITE WRAP MATERIAL

(76) Inventors: MICHAEL R. NOWAK, APPLETON, WI (US); LOUANN S. MUELLER, LITTLE CHUTE, WI (US); WILLIAM R. ARNDT, HILBERT, WI (US)

Correspondence Address: Philip M Weiss, Esq., Weiss & Weiss, 310 Old Country Road, Ste. 201, Garden, NY, 11530, US

(21) Appl. No.: 09/178,329

(22) Filed: Oct. 23, 1998

(51) Int. Cl. B32B 23/08

(52) U.S. Cl. 428/507; 428/511; 428/537.5

(57) ABSTRACT

A composite wrap material is provided for use in wrapping reams of paper and other materials. The wrap material is composed of a paper layer and a polymer film layer that are integrally bonded together by an adhesive layer interposed between the two layers. Also provided is a method of making and using the wrap material.

### FIELD OF THE INVENTION

The present invention relates to composite wrap materials for use as a protective covering in a variety of applications, and methods of making the composite wrap materials. More particularly, the invention relates to composite wrap materials used for packaging paper products.

### BACKGROUND OF THE INVENTION

Reams of paper for copy machines, computers, and other applications, are found in retail stores packaged in various composite or non-composite wrap materials. In addition to keeping the paper contained in the package, the wrap provides a moisture barrier that prevents or delays the absorption of moisture by the wrapped paper. The wrap also presents the paper contained inside in an eye appealing manner to the consumer.

Conventional commercial wrappers include paper\polyethylene\paper laminates, paper\wax\paper laminates, polyethylene-coated papers, wax-coated papers, and transparent polymer films. A drawback of paper-based wrap materials is their low burst strength. Oftentimes, such packages tend to break open before reaching the consumer because the wrapper is not strong enough to hold the paper upon repeated handling and stacking on store shelves. This not only ruins the product by causing an unsightly appearance on a store shelf, but can damage the paper which can cause copiers and printers to become jammed.

A disadvantage of film-based wrap materials that do not contain paper is that they are difficult to run on conventional packaging equipment during the wrapping process and require costly modifications to a paper packaging line. In addition, film-based wrap materials has a low burst strength, and lack the structural support of the heavier weight paper structures.

Another disadvantage of known wraps is that they process either like paper or film, depending on their major component. While providing a good dimensionally stable print surface, paper does not provide the gloss or the ink holdout of film structures. Film, while providing gloss and ink holdout, is more flexible and much more difficult to handle than paper due to its stretch properties.

As store distribution of such paper products has increased, paper companies have wanted to improve the graphics on the packaging for greater shelf appeal, and increase the strength of the wrappers to dependably contain a ream of paper until opened by the consumer.

Therefore, an object of the invention is to provide a composite wrap material that can be used to wrap a ream of paper or other material to provide a wrapped package having high burst strength. Another object is to provide a composite wrap material that will provide a barrier against moisture absorption by the wrapped contents. Another object is to provide a composite wrap material having the fold characteristics of paper. Yet another object is to provide a composite wrap material that can have a high gloss print surface or a standard paper print surface as desired. A further object is to provide a composite wrap material that can be provided in various forms according to different applications.

### SUMMARY OF THE INVENTION

These and other objects and advantages are achieved in the present composite wrap material, a process of making the wrap material, and use of the wrap material to package paper and other materials.

The composite wrap material of the invention is composed of a layer or sheet of a paper or cellulosic material and a layer of a polymer film material that are integrally bonded together by means of an adhesive layer interposed thereinbetween. The polymer film layer and/or the adhesive layer function to provide a moisture vapor barrier to protect the contents packaged within the wrap material.

The wrap material can provide a clear or transparent wrap such that a consumer can see the paper layer laminated to the polymer film layer. One or more layers can optionally contain a pigment to provide coloration. The wrap can also be provided with a high gloss print surface or a standard paper print surface. In another variation, the paper material and/or the polymer film can be a metalized material. In addition, the paper material can be printed before lamination so that the print shows through the film layer.

The composite paper/film wrap material can be prepared by laminating a three-layer structure composed of the layer of paper, the adhesive layer, and the polymer film layer, using a nip roller apparatus or other suitable laminating device. The paper and polymer film layers with the adhesive layer thereinbetween can be passed through a pair of nip rollers to bond the two layers together. The processing temperature can be maintained to control the processing temperature of the adhesive material.

Advantageously, the resulting composite wrap facilitates high burst strength of the final package, the option of a high gloss print surface or a standard paper print surface, a moisture barrier to prevent moisture absorption by the wrapped paper, and the fold characteristics of paper.

### BRIEF DESCRIPTION OF THE DRAWINGS

Throughout the following views, reference numerals will be used in the drawings, and the same reference numerals will be used throughout the several views and in the description to indicate same or like parts of the invention.

FIG. 1 is a cross-sectional view of a composite wrap material according to the invention; and

FIG. 2 is a schematic view of an apparatus used to produce the composite wrap material of FIG. 1.

### DESCRIPTION OF THE INVENTION

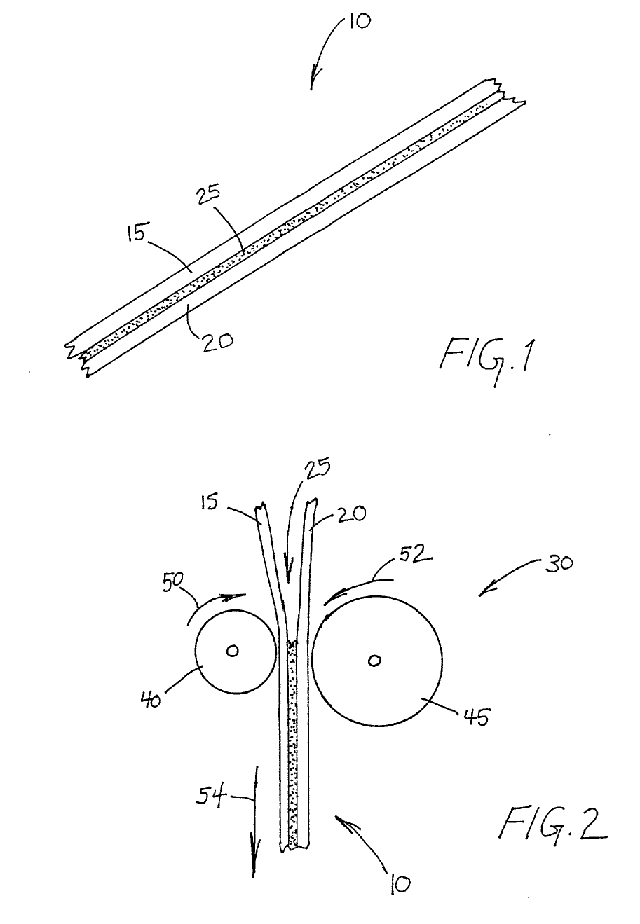

Referring now to the drawings, an embodiment of a composite wrap material of the invention according to the invention, generally designated with the numeral 10, is shown in cross-section in FIG. 1.

The composite wrap material 10 is made of a first layer 15 composed of a cellulosic material, a second layer 20 composed of a polymer-based film material, and an adhesive layer 25 positioned between the first and second layers. The present composite wrap material has an increased strength compared to conventional wrap materials, and is particularly effective in maintaining the integrity of a ream of paper packaged within the wrap material during handling.

The first layer 15 of the wrap material 10 can be any material composed primarily of cellulosic fibers. Suitable materials for use as the first layer 15 include, for example, machine-finished or machine-glazed paper, tissue paper, non-woven tissue paper, air-laid fabric, wet-laid fabric, and wet or dry creped tissue, or other types of paper. An exemplary material for the first layer 15 is a paper having good fold retention with a basis weight of about 5-80 lbs. per 3,000 sq. ft., preferably about 20-60 lbs. per 3,000 sq. ft. The caliper of the first layer 15 is such that the material can be readily run through a conventional wrapping apparatus used to package reams of paper.

The second layer 20 of the composite wrap material 10 is a polymer film material that, when bonded to the first layer 15 will increase the strength of the cellulosic material, and/or provides a high gloss surface over the first layer 15. Such materials include continuous polymer surfaces, for example, films of polyethylene, polypropylene including oriented polypropylene, poly(ethylene terephthalate) such as Mylar® polyesters, nylon, ionomer resin such as Surlyn® ionomer resins, polyester, and non-continuous, non-woven webs made of fibers composed of those polymer materials.

An adhesive layer 25 is interposed between the first and second layers 15, 20. The adhesive is typically in the form of a liquid or flowable material. Examples of useful adhesives include wax/polymer blends, polyethylene, polypropylene, polyvinylidene chloride, polyethylene acrylic acid, polypropylene, polyester, polyisobutylene, nylon, polymethylpentene, ethylene vinyl acetate, and copolymers thereof. Also useful are hot-melt adhesives, and wax/polymer blends. Such adhesive materials are further described in The Handbook of Adhesives, I. Skeist (ed.), 2d edition, Van Nostrand Reinhold Company, New York (1977), and Adhesives Handbook, J. Shields, Newnes-Butterworths, London (1976).

The polymer-based film second layer 20, and/or the adhesive layer 25, alone or in combination, form a moisture vapor barrier to inhibit the absorption of moisture by the paper or other material contained inside the wrapper. This helps protect a paper product from curling or warping.

Optionally, one or more of the three layers 15, 20, 25, of the composite wrap material can include a coloring agent to provide a transparent, or an opaque colored wrap material to mask the product contained within. Examples of coloring agents that will impart a transparent coloring effect include organic pigments such as a monazo pigment (Lake Red C, Nickel Azo Yellow), a diazo pigment (Benzidine Yellow), phthalocyanine pigments, and fluorescent pigments, among others. Coloring agents that will impart opacity include, for example, inorganic pigments such as titanium dioxide or barium sulfate (white), a metallic oxide pigment such as an iron oxide, zinc oxide or chromium oxide greens, ultramarine pigments, cadmium pigments, and pearlescent pigments, among others. A thin layer of metal can also be used as a pigment coating.

In use, one side of the wrap material is placed next to the paper or other material being wrapped. The other side of the wrap material may be printed upon using known printing techniques, or the paper layer 15 or film layer 20 can be printed before lamination, and then laminated so the print shows through the film layer.

The densities of the paper layer 15 and the polymer film layer 20 of the composite wrap material 10 can be varied to control the performance of the final structure on the packaging equipment.

The composite wrap material 10 can be prepared, for example, by extrusion lamination as schematically depicted in FIG. 2. The laminating device 30 includes two nip rollers 40, 45 that rotate in opposite directions, as shown by arrows 50, 52. Prior to passing through the nip rollers 40, 45, the paper layer 15 and film layer 20 are directed into an adjacent, non-contact position using known techniques. The adhesive material 25 is applied to the paper layer 15 and/or the film layer 20 in close proximity to the nip rollers. Preferably, the adhesive material 25 initially contacts one of the layers 15, 20 prior to passing into the nip rollers. As the layers 15, 20, 25, pass through the nip rollers 40, 45 in the direction of arrow 54, the three layers contact for the first time to form a three-layered wrap material 10. Preferably, the composite wrap material 10 is prepared such that the first and second layers 15, 25 are continuously bonded together with substantially no air pockets thereinbetween.

The temperature of the rollers 40, 45 can be varied according to the processing temperature of the adhesive material and the processing contact time. One or both of the rollers 40, 45 can be maintained at a temperature to cool and set the adhesive 25 as required. In a typical set-up, the surface temperature of the roller 45 is controlled for cooling the adhesive. In passing the two sheets 15, 20, and adhesive layer 25 through the laminating device 30, either the paper layer 15 or the film layer 20 can be placed in direct contact with the chilled roller.

The invention has been described by reference to detailed examples and methodologies. These examples are not meant to limit the scope of the invention. Variations within the concepts of the invention are apparent to those skilled in the art. The disclosures of the cited references throughout the application are incorporated by reference herein.

What is claimed is:

1. A composite wrap material, comprising:
a) a first layer composed of paper;
b) a second layer composed of a polymer film material; and
c) an adhesive layer between the first and second layers,
wherein the first and second layers are integrally bonded together by the adhesive layer, and the polymer film layer, the adhesive layer, or a combination of both provide a moisture vapor barrier.

2. The composite wrap material according to claim 1, wherein the first and second layers are continuously bonded together such that there are substantially no air pockets thereinbetween.

3. The composite wrap material according to claim 1, wherein the first layer is composed of a cellulosic material having fold retention and a basis weight of about 5-80 lbs./3,000 sq. ft.

4. The composite wrap material according to claim 1, wherein the first layer is composed of a cellulosic material having fold retention and a basis weight of about 20-60 lbs./3,000 sq. ft.

5. The composite wrap material according to claim 1, wherein the first layer is composed of a cellulosic material selected from the group consisting of machine finished paper, machine glazed paper, tissue, tissue, air laid fabric, wet laid fabric, creped tissue, and a metalized paper.

6. The composite wrap material according to claim 1, wherein the second layer is composed of a polymer material selected from the group consisting of polyethylene, polypropylene, poly(ethylene terephthalate), nylon, ionomer resin, and polyester.

7. The composite wrap material according to claim 1, wherein the second layer is a non-continuous, non-woven web comprised of fibers of a polymer material selected from the group consisting of polyethylene, poly(ethylene terephthalate), polypropylene, nylon, ionomer resin, and polyester.

8. The composite wrap material according to claim 1, wherein the adhesive layer is composed of a polymer material selected from the group consisting of polyethylene, polypropylene, polyvinylidene chloride, polyethylene acrylic acid, polyester, polyisobutylene, nylon, polymethylpentene, and ethylene vinyl acetate, and copolymers thereof.

9. The composite wrap material according to claim 1, wherein the adhesive layer is composed of a wax/polymer blend.

10. The composite wrap material according to claim 1, wherein the adhesive layer is composed of a hot-melt adhesive.

11. The composite wrap material according to claim 1, wherein one or more of the layers are pigmented.

12. The composite wrap material according to claim 1, wherein a surface of the first or second layer is composed of a metalized material.

13. A process for making a composite wrap material, comprising:
a) providing a first sheet of a cellulosic material, a second sheet of a polymer film, and an adhesive material;
b) applying the adhesive material to a surface of the first sheet, the second sheets, or both;
c) conveying the first and second sheets into a laminating apparatus, with the adhesive material interposed between the first and second sheets;
d) laminating the two sheets to bond the first and second layers together and form an integral composite wrap material.

14. The process according to claim 13, wherein step b) further comprises:
maintaining the temperature of the laminating step at the processing temperature of the adhesive material.

15. A ream of paper wrapped together as a package with a sheet of the composite wrap material of claim 1, wherein the composite wrap provides a high burst strength of the packaged paper.

16. The ream of paper according to claim 15, wherein the composite wrap material provides a barrier to effectively prevent moisture absorption and curling of the packaged paper.

17. The ream of paper according to claim 15, wherein the composite wrap material has the fold characteristics of paper.
